(19) United States
(12) Patent Application Publication
(10) Pub. No.: US 2016/0014698 A1
(43) Pub. Date: Jan. 14, 2016

(54) METHOD, ELECTRONIC APPARATUS, AND COMPUTER PROGRAM PRODUCT

(71) Applicant: KABUSHIKI KAISHA TOSHIBA, Tokyo (JP)

(72) Inventors: Keisuke YASUI, Tachikawa Tokyo (JP); Kouichi OGI, Hanno Saitama (JP)

(21) Appl. No.: 14/605,844

(22) Filed: Jan. 26, 2015

(30) Foreign Application Priority Data
Jul. 8, 2014 (JP) 2014-140306

(51) Int. Cl. H04W 52/02

(52) U.S. Cl. CPC H04W 52/0251

(57) ABSTRACT

According to one embodiment, a method for controlling an electronic apparatus capable of communicating with a wearable electronic device includes: restricting at least one function of the electronic apparatus based on a signal received from the wearable electronic device, the signal being usable in measuring a distance between the wearable electronic device and the electronic apparatus; and reducing traffic of the signal between the wearable electronic device and the electronic apparatus from a first level to a second level while the electronic apparatus is directly operated by a user.

### CROSS-REFERENCE TO RELATED APPLICATIONS

This application is based upon and claims the benefit of priority from Japanese Patent Application No. 2014-140306, filed Jul. 8, 2014, the entire contents of which are incorporated herein by reference.

### FIELD

Embodiments described herein relate generally to a method, an electronic apparatus, and a computer program product.

BACKGROUND

Conventionally, there has been known an electronic apparatus which changes over between a low power consumption mode and a normal mode based on a predetermined control signal received from another device.

In the conventional electronic apparatus as described above, it is desirable to achieve power saving according to usages of a user without using the predetermined control signal for changing over the mode.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating a personal computer (PC) and portable devices according to an embodiment;

FIG. 2 is an exemplary block diagram illustrating internal configurations of the PC and the portable device in the embodiment;

FIG. 3 is an exemplary block diagram illustrating a functional configuration of a control program executed by a CPU of the PC in the embodiment;

FIG. 4 is an exemplary flowchart illustrating processing performed by each module of the control program to change over a state of the PC in the embodiment;

FIG. 5 is an exemplary flowchart illustrating processing performed by each module of the control program when the PC is in an unlocked state in the embodiment;

FIG. 6 is an exemplary flowchart illustrating processing performed by each module of the control program when a communication function of the PC is off in the embodiment;

FIG. 7 is an exemplary sequence diagram illustrating processing performed by a PC and a portable device according to a modification of the embodiment; and

FIG. 8 is another exemplary sequence diagram illustrating processing performed by the PC and the portable device in the modification.

### DETAILED DESCRIPTION

In general, according to one embodiment, a method for controlling an electronic apparatus capable of communicating with a wearable electronic device comprises: restricting at least one function of the electronic apparatus based on a signal received from the wearable electronic device, the signal being usable in measuring a distance between the wearable electronic device and the electronic apparatus; and reducing traffic of the signal between the wearable electronic device and the electronic apparatus from a first level to a second level while the electronic apparatus is directly operated by a user.

### Embodiment

An embodiment will be described below with reference to the accompanying drawings.

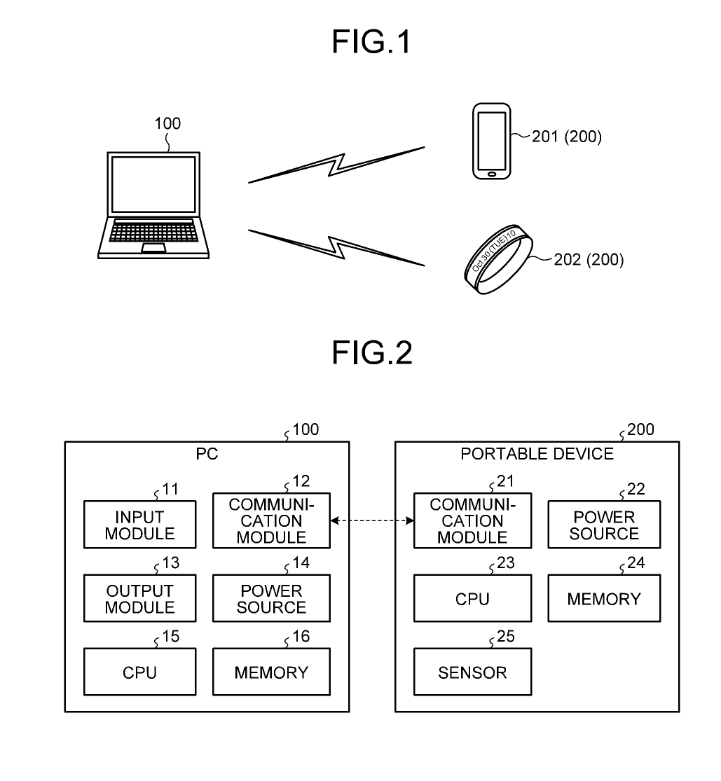

With reference to FIG. 1, a personal computer (PC) 100 and a portable device 200 according to an embodiment will be described below. The PC 100 is an example of an “electronic apparatus” and the portable device 200 is an example of a “wearable electronic device”.

As illustrated in FIG. 1, the PC 100 is configured to be capable of performing wireless communication with the portable device 200. An example of a communication system applicable thereto is Bluetooth (registered trademark); however, the communication system should not be limited to Bluetooth (registered trademark).

The portable device 200 is an information processing device to be carried by a user. FIG. 1 illustrates a smartphone 201 and a wearable device 202 as examples of the portable device 200. Any commonly found portable device may nonetheless be used in the embodiment. It is noted that the wearable device 202 is an information processing device that can be worn and used by the user.

The following describes internal configurations of the PC 100 and the portable device 200 in detail with reference to FIG. 2.

As illustrated in FIG. 2, the PC 100 comprises an input module 11, a communication module 12, an output module 13, a power source 14, a central processing unit (CPU) 15, and a memory 16.

The input module 11 is an input interface, such as a keyboard and a touch panel, provided for receiving the input operation from the user. The communication module 12 is a communication interface used for communicating with another device (portable device 200).

The output module 13 is an output interface, such as a display that displays various types of information as an image and a speaker that outputs various types of information as audio. The power source 14 supplies each component of the PC 100 with electrical power. The power source 14 may, for example, be a battery.

The CPU 15 executes various types of computer programs to thereby perform various types of processing for controlling each component of the PC 100. The memory 16 comprises a read only memory (ROM) and a random access memory (RAM) and stores therein the various types of computer programs and data used by the CPU 15 to perform the various types of processing.

As illustrated in FIG. 2, the portable device 200 comprises a communication module 21, a power source 22, a CPU 23, a memory 24, and a sensor 25.

The communication module 21 is a communication interface used for communicating with another device (PC 100). The power source 22 supplies each component of the portable device 200 with electrical power. The power source 22 may, for example, be a mobile battery.

The CPU 23 performs various types of processing for controlling each component of the portable device 200. The memory 24 stores therein various types of computer programs and data used by the CPU 23 to perform the various types of processing.

The sensor 25 is a sensor device, such as an acceleration sensor, a pulse sensor, a temperature sensor, an atmospheric pressure sensor, and the like. Although not illustrated in FIG. 2, the portable device 200 may comprise an output device such as a display and an input device such as a touch panel.

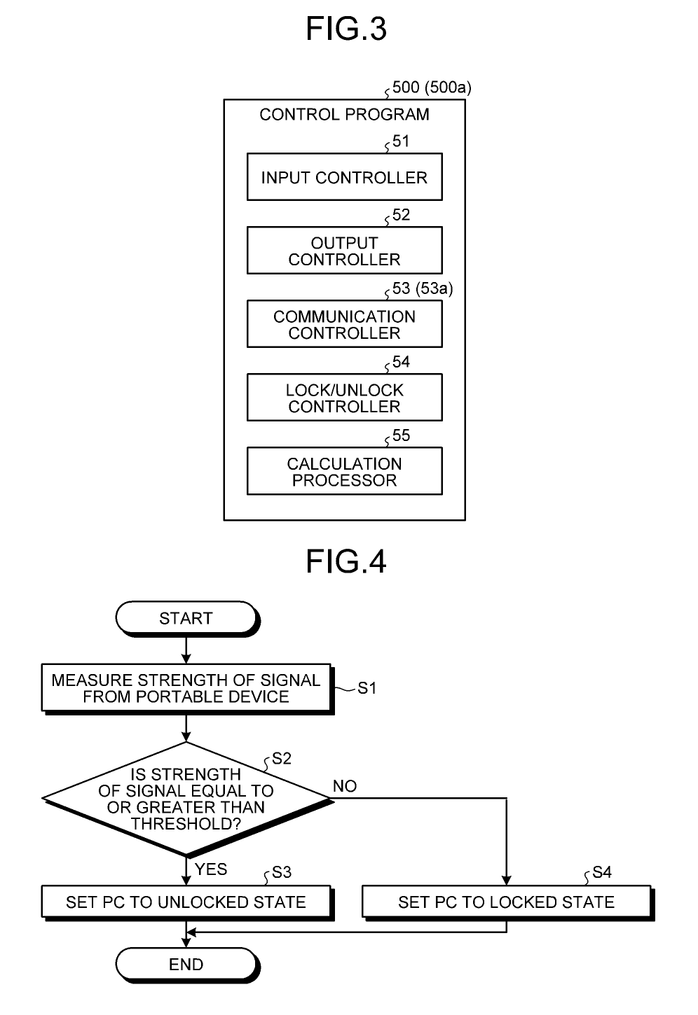

In the embodiment, the CPU 15 of the PC 100 is configured to execute a control program 500 as illustrated in FIG. 3. The control program 500 has a modular configuration as described below.

As illustrated in FIG. 3, the control program 500 comprises, as a functional configuration, an input controller 51, an output controller 52, a communication controller 53, a lock/unlock controller 54, and a calculation processor 55. Each of these modules is generated on the RAM of the memory 16 as a result of the CPU 15 loading the control program 500 from the ROM of the memory 16 and executing the loaded control program 500.

The input controller 51 is configured to detect the input operation performed by the user via the input module 11. The output controller 52 is configured to control, for example, a video output and an audio output to the output module 13.

The communication controller 53 is configured to control transmission and reception of various types of data via the communication module 12. The lock/unlock controller 54 is configured to change over a state of the PC 100 between a locked state and an unlocked state described below. The calculation processor 55 has a function of performing various types of calculation processing.

In the embodiment, when the PC 100 and the portable device 200 are capable of communicating with each other, the communication controller 53 is configured to periodically receive a predetermined signal (data) from the portable device 200. The lock/unlock controller 54 is configured to restrict at least part of operations performed on the PC 100 according to strength of the signal received from the portable device 200.

For example, when the strength of the signal received from the portable device 200 is smaller than a threshold, the PC 100 and the portable device 200 can be determined to be positioned far from each other. Thus, in this case, in order to disable any user other than the user who carries the portable device 200 with him or her to operate the PC 100, the lock/unlock controller 54 sets the state of the PC 100 to a locked state in which reception of, for example, a direct input operation to the PC 100 is restricted.

In contrast, when the strength of the signal received from the portable device 200 is equal to or greater than the threshold, the PC 100 and the portable device 200 can be determined to be positioned close to each other. Thus, in this case, in order to enable the user who carries the portable device 200 with him or her to operate the PC 100, the lock/unlock controller 54 sets the state of the PC 100 to an unlocked state in which reception of, for example, the direct input operation to the PC 100 is permitted.

The abovementioned threshold is exemplary determined with reference to the strength of the signal received from the portable device 200 in a condition in which the user who carries the portable device 200 with him or her operates the PC 100.

Here, in a condition in which the user who carries the portable device 200 with him or her performs the input operation on the PC 100 in the unlocked state, the PC 100 and the portable device 200 are positioned close to each other. Therefore, in this condition, there is no need to measure the strength of the signal received from the PC 100 in order to determine a positional relation between the PC 100 and the portable device 200.

Thus, in the embodiment, when the input controller 51 detects the input operation performed by the user on the PC 100 set to the unlocked state, the communication controller 53 reduces traffic between the PC 100 and the portable device 200 by turning off a communication function of the PC 100 (a function for communicating with the portable device 200).

In the above description, the method for reducing the traffic has been exemplified by the turning off of the communication function of the PC 100 (the function for communicating with the portable device 200). In the embodiment, however, any method may be used as long as the method can reduce the traffic from a first level to a second level smaller than the first level. For example, a method of reducing a frequency of communication between the PC 100 and the portable device 200 may be used. Alternatively, a method of reducing the volume of data transmitted and received between the PC 100 and the portable device 200 may be used.

Here, when the communication function of the PC 100 is kept off, no signal is transmitted and received between the PC 100 and the portable device 200. Thus, the state of the PC 100 cannot be changed over based on the strength of the signal. This requires that the communication function that has been turned off be turned back on in order to change over the state of the PC 100 from the unlocked state to the locked state when the user who carries the portable device 200 with him or her completes the input operation on the PC 100 and leaves the PC 100.

Thus, in the embodiment, when the input operation by the user is not detected for a certain period of time or longer, the communication controller 53 turns back on the communication function of the PC 100. In other words, when the input operation by the user is not detected for a certain period of time or longer, the communication controller 53 resumes reception of a signal from the portable device 200, and changes over the state of the PC 100 between the locked state and the unlocked state according to the strength of the received signal.

It is noted that, in the embodiment, when the communication function of the PC 100 is off, the communication controller 53 may periodically determine whether a signal can be received from the portable device 200. That is, the communication function of the PC 100 may be periodically turned on at a timing at which the communication controller 53 determines whether a signal can be received from the portable device 200.

The following describes, with reference to FIG. 4, processing performed by each module of the control program 500 to change over the state of the PC 100 in the embodiment.

In the embodiment, as illustrated in FIG. 4, the calculation processor 55 measures at S1 the strength of the signal received by the communication controller 53 from the portable device 200. S2 is then performed.

At S2, based on the measurement at S1, the calculation processor 55 determines whether the strength of the signal from the portable device 200 is equal to or greater than the threshold. The threshold is exemplary determined with reference to the strength of the signal received from the portable device 200 in a condition in which the user who carries the portable device 200 with him or her operates the PC 100.

When it is determined at S2 that the strength of the signal is equal to or greater than the threshold, S3 is then performed. At S3, the lock/unlock controller 54 sets the state of the PC 100 to the unlocked state. Specifically, when the strength of the signal is equal to or greater than the threshold, the PC 100 and the portable device 200 are positioned close to each other. Thus, in this case, in order to enable the user of the portable device 200 to operate the PC 100, the lock/unlock controller 54 sets the state of the PC 100 to the unlocked state in which the input operation or the like on the PC 100 is enabled.

When it is determined at S2 that the strength of the signal is smaller than the threshold, S4 is then performed. At S4, the lock/unlock controller 54 sets the state of the PC 100 to the locked state. Specifically, when the strength of the signal is smaller than the threshold, the PC 100 and the portable device 200 are positioned far from each other. Thus, in this case, in order to disable any user other than the user of the portable device 200 to operate the PC 100, the lock/unlock controller 54 sets the state of the PC 100 to the locked state in which the input operation or the like on the PC 100 is restricted.

The processing is terminated after the performance of S3 or S4.

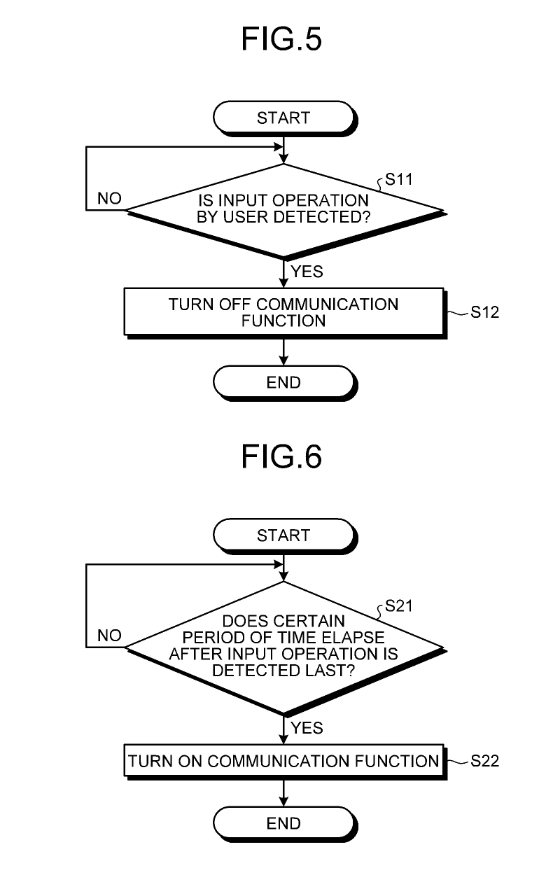

The following describes, with reference to FIG. 5, processing performed by each module of the control program 500 when the PC 100 is in the unlocked state in the embodiment.

In the embodiment, as illustrated in FIG. 5, the calculation processor 55 determines at S11 whether the input controller 51 detects the input operation performed by the user. S11 is repeatedly performed until the input operation by the user is determined to be detected. When it is determined at S11 that the input operation by the user is detected, S12 is then performed.

At S12, the communication controller 53 turns off the communication function of the PC 100 (the function for communicating with the portable device 200). The traffic between the PC 100 and the portable device 200 is thereby reduced. It is noted that the portable device 200 in the embodiment may be configured so as to turn off a communication function thereof (a function for communicating with the PC 100) when the communication function of the PC 100 is turned off. The processing is then terminated.

The following describes, with reference to FIG. 6, a process performed by each module of the control program 500 when the communication function of the PC 100 in the embodiment is off.

In the embodiment, as illustrated in FIG. 6, the calculation processor 55 determines at S21 whether a certain period of time elapses after the input operation by the user on the PC 100 is detected last. S21 is repeatedly performed until the certain period of time is determined to have elapsed after the input operation by the user was detected last. When it is determined at S21 that the certain period of time is determined to have elapsed after the input operation by the user was detected last, S22 is then performed.

At S22, the communication controller 53 turns on the communication function of the PC 100 (the function for communicating with the portable device 200). When the communication function of the portable device 200 (the function for communicating with the PC 100) is also on at this time, the PC 100 can resume reception of a signal from the portable device 200 for changing over between the locked state and the unlocked state. The processing is then terminated.

As described heretofore, the communication controller 53 in the embodiment is configured to reduce the traffic between the PC 100 and the portable device 200 by setting the PC 100 to the unlocked state when the input operation by the user on the PC 100 is detected. This prevents communication from being carried out between the PC 100 and the portable device 200 when there is no need to change over between the locked state and the unlocked state because the user of the portable device 200 is performing an input operation on the PC 100. As a result, power saving can be achieved according to usages of the user without using, for example, a predetermined control signal for changing over between a low power consumption mode and a normal mode.

### Modification of Embodiment

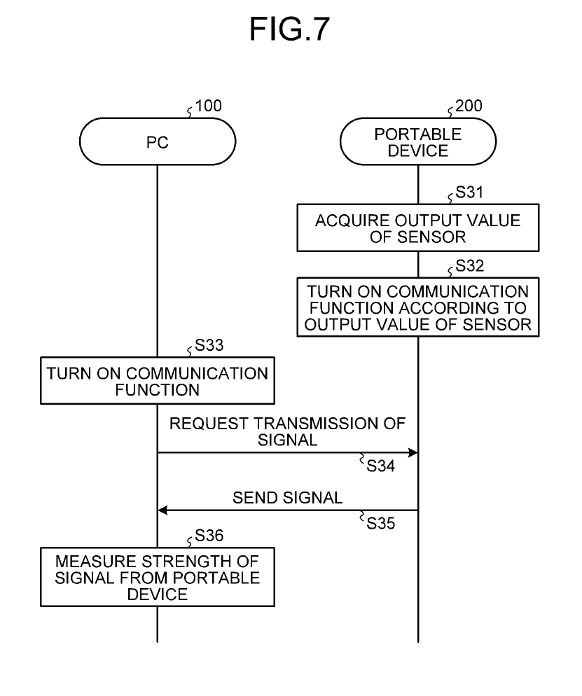

A modification of the embodiment will be described below with reference to FIGS. 3 and 7. The modification shares a basic configuration with the above-described embodiment except for the following.

A communication controller 53a in the modification (see FIG. 3) receives a signal from the portable device 200 based on an output value of the sensor 25 comprised in the portable device 200 when the user carries the portable device 200 with him or her. The following describes in detail, with reference to FIG. 7, a timing at which the PC 100 receives a signal from the portable device 200, the PC 100 being configured to execute a control program 500a in the modification (see FIG. 3).

In the modification, as illustrated in FIG. 7, the portable device 200 acquires an output value of the sensor 25 comprised in the portable device 200 at S31.

Then at S32, the portable device 200 turns on the communication function for communicating with the PC 100 according to the output value of the sensor 25 acquired at S31.

When, for example, the sensor 25 is the acceleration sensor, monitoring a change in the output value of the acceleration sensor allows a determination to be performed as to whether the user moves while carrying the portable device 200 with him or her, or the user leaves the portable device 200 to stand without carrying the same with him or her. Alternatively, when the sensor 25 is the pulse sensor, monitoring a change in the output valve of the pulse sensor allows a determination to be performed as to whether the user wears the portable device 200 (in this case, the wearable device 202). Thus, the portable device 200 can turn on the communication function for communicating with the PC 100 according to the output value of the sensor 25 only when the user carries the portable device 200 with him or her. In other words, the portable device 200 can turn on the communication function for communicating with the PC 100 when the output value of the sensor 25 is in a first state, and can turn off the communication function for communicating with the PC 100 when the output value of the sensor 25 is in a second state different from the first state. The following describes subsequence to be followed when the communication function of the portable device 200 is turned on at S32.

When the communication function of the portable device 200 is turned on at S32, the PC 100 turns on the communication function for communicating with the portable device 200 at S33. Then at S34, the PC 100 requests the portable device 200 to send a signal used to determine whether the PC 100 is positioned far from or close to the portable device 200.

At S35, the portable device 200 sends to the PC 100 a signal in response to the request performed by the PC 100 at S34. Then at S36, the PC 100 measures the strength of the signal from the portable device 200. This allows a determination to be performed as to whether the PC 100 is positioned far from or close to the portable device 200. According to a result of the determination, the state of the PC 100 is set to the locked state or the unlocked state.

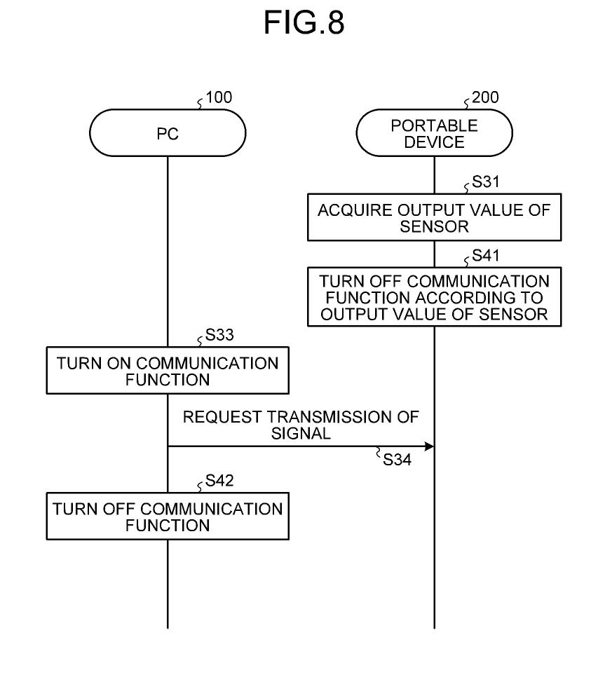

As described above, FIG. 7 illustrates a case in which the portable device 200 turns on the communication function for communicating with the PC 100 according to the value of the sensor 25. However, in the modification, another case is possible in which, as illustrated in FIG. 8, the portable device 200 turns off the communication function for communicating with the PC 100 according to the value of the sensor 25 (S41). In this case, even when the PC 100 requests the portable device 200 to send a signal (S34) after having turned on the communication function for communicating with the portable device 200 (S33), the portable device 200 does not send a signal to the PC 100 because the communication function of the portable device 200 is off. Thus, in the case illustrated in FIG. 8, the PC 100 turns off the communication function for communicating with the portable device 200 (S42) because of the communication with the portable device 200 being disabled.

As described above, in the modification, the PC 100 is configured to receive a signal from the portable device 200 when the user carries the portable device 200 with him or her, and not to receive a signal from the portable device 200 when the user does not carry the portable device 200 with him or her, based on a change in the output value of the sensor 25 comprised in the portable device 200. This prevents the communication from being carried out between the PC 100 and the portable device 200 when there is no need to change over between the locked state and the unlocked state while the user of the portable device 200 leaves to stand the portable device 200 without carrying the same with him or her. As a result, power saving can be appropriately achieved according to the usages of the user.

The control program 500 in the embodiment and the control program 500a in the modification are provided as installable or executable computer program products. In other words, each of the control programs 500 and 500a is provided as a computer program product having a non-transitory computer readable medium such as a compact disc read only memory (CD-ROM), a flexible disk (FD), a compact disc recordable (CD-R), and a digital versatile disc (DVD).

Each of the control programs 500 and 500a may be stored in a computer connected to a network such as the Internet and provided or distributed via the network. Furthermore, each of the control programs 500 and 500a may be embedded and provided in a ROM, for example.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for controlling an electronic apparatus capable of communicating with a wearable electronic device, the method comprising:
restricting at least one function of the electronic apparatus based on a signal received from the wearable electronic device, the signal usable for measuring a distance between the wearable electronic device and the electronic apparatus; and
reducing traffic of the signal between the wearable electronic device and the electronic apparatus from a first level to a second level while the electronic apparatus is directly operated by a user.

2. The method of claim 1, further comprising:
returning the traffic of the signal from the second level to the first level when the electronic apparatus is not directly operated by a user for a certain period of time or longer after the reducing the traffic.

3. The method of claim 1, further comprising:
receiving the signal from the wearable electronic device only when a user wears the wearable electronic device.

4. The method of claim 1, further comprising:
receiving the signal from the wearable electronic device when an output value of a sensor in the wearable electronic device indicates a first state; and
refusing to receive the signal from the wearable electronic device when the output value of the sensor in the wearable electronic device indicates a second state different from the first state.

5. The method of claim 1, further comprising:
reducing the traffic of the signal to the second level by temporarily turning off a communication function of the electronic apparatus.

6. An electronic apparatus capable of communicating with a wearable electronic device, the electronic apparatus comprising:
circuitry configured to restrict at least one function of the electronic apparatus based on a signal received from the wearable electronic device, and to reduce traffic of the signal between the wearable electronic device and the electronic apparatus from a first level to a second level while the electronic apparatus is directly operated by a user, the signal being usable for measuring a distance between the wearable electronic device and the electronic apparatus.

7. The electronic apparatus of claim 6, wherein the circuitry is further configured to return the traffic of the signal from the second level to the first level when the electronic apparatus is not directly operated by a user for a certain period of time or longer after the traffic of the signal has been reduced to the second level.

8. The electronic apparatus of claim 6, wherein the circuitry is further configured to receive the signal from the wearable electronic device only when a user wears the wearable electronic device.

9. The electronic apparatus of claim 6, wherein the circuitry is further configured to receive the signal from the wearable electronic device when an output value of a sensor in the wearable electronic device indicates a first state, and not to receive the signal from the wearable electronic device when the output value of the sensor in the wearable electronic device indicates a second state different from the first state.

10. The electronic apparatus of claim 6, wherein the circuitry is further configured to reduce the traffic of the signal to the second level by temporarily turning off a communication function of the electronic apparatus.

11. A computer program product having a non-transitory computer readable medium including programmed instructions for controlling an electronic apparatus capable of communicating with a wearable electronic device, wherein the instructions, when executed by a computer, cause the computer to:
restrict at least one function of the electronic apparatus based on a signal received from the wearable electronic device, the signal being usable for measuring a distance between the wearable electronic device and the electronic apparatus; and
reduce traffic of the signal between the wearable electronic device and the electronic apparatus from a first level to a second level while the electronic apparatus is directly operated by a user.

12. The computer program product of claim 11, wherein the instructions further cause the computer to:
return the traffic of the signal from the second level to the first level when the electronic apparatus is not directly operated by a user for a certain period of time or longer after the reducing the traffic.

13. The computer program product of claim 11, wherein the instructions further cause the computer to:
receive the signal from the wearable electronic device only when a user wears the wearable electronic device.

14. The computer program product of claim 11, wherein the instructions further cause the computer to:
receive the signal from the wearable electronic device when an output value of a sensor in the wearable electronic device indicates a first state; and
refuse to receive the signal from the wearable electronic device when the output value of the sensor comprised in the wearable electronic device indicates a second state different from the first state.

15. The computer program product of claim 11, wherein the instructions cause the computer to reduce the traffic of the signal to the second level by temporarily turning off a communication function of the electronic apparatus.
